(19) United States
(12) Patent Application Publication
(10) Pub. No.: US 2009/0320254 A1
(43) Pub. Date: Dec. 31, 2009

(54) METHOD OF MANUFACTURING SOLID ELECTROLYTIC CAPACITOR

(75) Inventor: Satoru Yoshimitsu, Kishima-gun (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignees: SANYO ELECTRIC CO., LTD., Osaka (JP); SAGA SANYO INDUSTRIES CO., LTD., Kishima-gun (JP)

(21) Appl. No.: 12/490,779

(22) Filed: Jun. 24, 2009

(30) Foreign Application Priority Data
Jun. 26, 2008 (JP) 2008-167480

(51) Int. Cl. H01G 9/00

(52) U.S. Cl. 29/25.03

(57) ABSTRACT

A solid electrolytic capacitor having excellent heat resistance is provided without using a transition metal salt as a dopant and oxidant. In a method of manufacturing a solid electrolytic capacitor including a solid electrolyte made of a conductive polymer, the conductive polymer is formed by performing an oxidative polymerization reaction by brining a monomer and a dopant into contact with each other. The dopant contains an imidazolium salt of sulfonic acid.

### BACKGROUND OF THE INVENTION

1. Field of the Invention

The present invention relates to a method of manufacturing a solid electrolytic capacitor including a solid electrolyte made of a conductive polymer.

2. Description of the Background Art

In recent years, a compact, large-capacity and heat-resistant capacitor with a low impedance in a high frequency range is required with digitization and realization of high frequency of electronics and also with increased reflow temperature due to lead-free solder.

In response to the request for a small size and large capacity capacitor with a low impedance in a high frequency range, a wound-type electrolytic capacitor is produced in which a capacitor element having a cathode foil and an anode foil wound with a separator interposed therebetween is placed in a metal case and sealed with sealing rubber, whereby size reduction and capacity increase can be realized. In such a capacitor, it is proposed to use a conductive polymer having high conductivity such as polypyrrole or polythiophene as a solid electrolyte. As a solid electrolytic capacitor including a conductive polymer as a solid electrolyte, for example, such a solid electrolytic capacitor is known that includes polyethylenedioxythiophene as a solid electrolyte obtained by impregnating a capacitor element having an anode foil and a cathode foil wound with a separator interposed therebetween with 3,4-ethylenedioxythiophene and an oxidant and then subjecting them to a polymerization reaction (for example, Japanese Patent Laying-Open No. 2005-109248).

The aforementioned solid electrolytic capacitor uses a ferric salt of sulfonic acid serving as both a dopant and an oxidant. In a case where a conductive polymer is formed by a chemical oxidative polymerization method, a large amount of ferric iron has to be present in a polymerization solution at a time of the chemical oxidative polymerization in order to increase a polymerization yield. Here, since the valence of ferric iron is 3 and the valence of sulfonic acid is 1, 3 moles of sulfonic acid are present with respect to 1 mole of ferric iron in terms of stoichiometric ratio, which means that the amount of sulfonic acid present in the polymerization solution is three times as large as that of ferric iron. Although a small portion of the sulfonic acid in this polymerization solution is taken as a dopant into the conductive polymer during the chemical oxidative polymerization, most of the sulfonic acid not only remains in the polymerization solution but also exists as an impurity in the solid electrolyte. Most of the sulfonic acid present in the solid electrolyte exists in the form of a ferrous salt and a ferric salt of sulfonic acid. Since they have high deliquescence, when the solid electrolytic capacitor is used for a long term under a high-humidity environment, moisture entering the inside of the capacitor is absorbed and a large amount of sulfonate anion is produced inside the capacitor, thereby deteriorating the anode foil, the cathode foil, and the dielectric coating film, and causing a capacitance reduction and an increase in ESR (Equivalent Series Resistance) in an endurance and heat-resistance test.

Furthermore, in a reflow process for mounting a solid electrolytic capacitor on a printed circuit board and in an endurance and heat-resistance test for a long time, a large amount of ferrous iron that remains in the solid electrolyte of the solid electrolytic capacitor functions as a reducer and therefore reduces oxygen of the dielectric coating film. Accordingly, a defect due to lack of oxygen occurs in the dielectric coating film, causing an increase in leakage current in the solid electrolytic capacitor, a short-circuit failure, and the like.

As described above, the solid electrolytic capacitor including a conductive polymer as a solid electrolyte has such problems as deterioration of electric characteristics or short-circuits due to the deteriorated conductive polymer resulting from various factors.

### SUMMARY OF THE INVENTION

In view of the forgoing problems, the present invention provides a method of manufacturing a solid electrolytic capacitor including a solid electrolyte made of a conductive polymer. The conductive polymer is formed by performing an oxidative polymerization reaction by bringing a monomer and a dopant into contact with each other. The dopant contains an imidazolium salt of sulfonic acid.

Preferably, the imidazolium salt of sulfonic acid is formed of a sulfonate ion and an imidazolium ion, and the sulfonate ion is phenolsulfonate ion. Preferably, the imidazolium ion is 2-methylimidazolium ion.

In the present invention, the imidazolium salt of sulfonic acid is formed of a sulfonate ion and an imidazolium ion. Preferably, the sulfonate ion is included in an amount of 0.5-1.5 moles with respect to 1 mole of the imidazolium ion, in a solution containing the dopant for use in the oxidative polymerization reaction.

Preferably, the oxidative polymerization reaction is performed additionally using an ammonium salt as an oxidant.

Preferably, the oxidative polymerization reaction is performed under a reduced-pressure atmosphere.

According to the present invention, a conductive polymer formed using an imidazolium salt of sulfonic acid as a dopant is used as a solid electrolyte. A solid electrolytic capacitor excellent in heat resistance is thus provided.

The foregoing and other objects, features, aspects and advantages of the present invention will become more apparent from the following detailed description of the present invention.

### DESCRIPTION OF THE PREFERRED EMBODIMENTS

The best mode for carrying out the present invention will be described. A solid electrolytic capacitor in accordance with the present invention is produced as follows. First, an anode foil and a cathode foil are wound with a separator interposed and are fixed by a fixing tape, thereby fabricating a capacitor element. Here, the respective lead wires serving as terminals are connected to the anode foil and the cathode foil through, for example, aluminum tabs. The number of lead wires connected to each of the anode foil and the cathode foil is not limited as long as one or more are connected. The number of anode foils and the number of cathode foils each may be one or more. Furthermore, the number of anode foils and the number of cathode foils may be the same or may be different. Of the anode foil and the cathode foil, at least the anode foil has a dielectric coating film made of an oxide coating film or the like on the surface thereof. Each of the anode foil, the cathode foil, the dielectric coating film, and the lead wire may be produced using a known material and by a known technique.

A polymerization solution is then prepared. In the present specification, a polymerization solution means the entire solution used in an oxidative polymerization reaction and may be made of one solution or may be made of a plurality of solutions. For example, the polymerization solution may be a mixed solution including a monomer forming a conductive polymer, a dopant, and the like. Alternatively, a solution containing a monomer (also abbreviated as a monomer solution hereinafter) and a solution containing a dopant (also abbreviated as a dopant solution hereinafter) may be separately prepared.

The aforementioned monomer may be the known ones. The monomer is selected as appropriate, for example, from among thiophene, pyrrole, aniline, and derivatives thereof.

In the present invention, an imidazolium salt of sulfonic acid is used as the aforementioned dopant. The imidazolium salt of sulfonic acid is formed of a sulfonate ion and an imidazolium ion.

Examples of the aforementioned sulfonate ion include an alkylsulfonate ion such as methanesulfonate ion or ethanesulfonate ion, an aromatic sulfonate ion such as benzenesulfonate ion or naphthalenesulfonate ion, an anion of an aromatic sulfonate derivative such as toluenesulfonate ion, methoxybenzenesulfonate ion or phenolsulfonate ion, and the like. Among them, phenolsulfonate ion with aromaticity and good heat-resistance is preferably used.

Examples of the aforementioned imidazolium ion include an unmodified imidazolium ion, a cation of an imidazole derivative such as 1-methylimidazolium ion or 2-methylimidazolium ion, and the like. Among them, when a dopant containing 2-methylimidazolium ion is used, good heat-resistance is exhibited. In other words, when phenolsulfonate 2-methylimidazole is used as a dopant, a solid electrolytic capacitor having more excellent heat-resistance can be produced as compared with when other imidazolium salts of sulfonic acid are used.

The content of the sulfonate ion in the solution containing the above-noted dopant is preferably in a range of 0.5-1.5 moles with respect to 1 mole of imidazolium ion in order to produce a particularly heat-resistant solid electrolytic capacitor.

A solvent used for the solution containing at least the above-noted dopant is preferably selected from methanol, ethanol, propanol, butanol, and water. In particular, when 3,4-ethylenedioxythiophene is employed as a monomer forming a conductive polymer, water is preferably used, considering the miscibility with 3,4-ethylenedioxythiophene and the manufacturing costs.

The solution containing at least the above-noted dopant further has an oxidant. Inclusion of an oxidant in the polymerization solution allows the polymerization reaction to proceed well and allows formation of a good solid electrolyte when the oxidative polymerization reaction is performed not only by a chemical oxidative polymerization method but also by an electrolytic oxidative polymerization method. The solution containing a dopant and an oxidant may be prepared by adding an oxidant to a solution containing a dopant and stirring the solution or may be prepared by preparing a solution containing a dopant and a solution containing an oxidant and then mixing and stirring these solutions. An example of the aforementioned oxidant is an ammonium salt such as ammonium sulfate, ammonium persulfate, ammonium oxalate, or ammonium perchlorate. Among them, ammonium persulfate is preferably used. When a solution containing an oxidant is prepared in the foregoing manner, the concentration of the oxidant in the solution is 50 wt % or less, in view of solubility.

When different solutions of a solution of containing a monomer and a solution containing a dopant are used as the aforementioned polymerization solution, the concentration of the dopant in the solution containing the dopant is preferably 20 wt % or more, and further preferably 40 wt % or more. Inclusion of a dopant in a concentration as high as 40 wt % or more allows an oxidant and dopant solution to be prepared well and quickly as a result of contact with the high-concentration oxidant solution.

A solid electrolyte made of a conductive polymer is formed by preparing the above-described polymerization solution and performing a chemical oxidative polymerization method or an electrolytic oxidative polymerization method using the polymerization solution. Here, a chemical oxidative polymerization method is used, by way of example.

In a chemical oxidative polymerization method, the aforementioned capacitor element is dipped in the aforementioned polymerization solution, or the aforementioned capacitor element is impregnated with the aforementioned polymerization solution by coating the capacitor element with the polymerization solution.

An oxidative polymerization reaction is initiated by impregnating the capacitor element with the polymerization solution. Preferably, the capacitor element is left for 1-6 hours, preferably 2-3 hours at room temperature under a reduced-pressure atmosphere. Here, the pressure is preferably the atmospheric pressure—80 kPa, or lower. Leaving the capacitor element under a reduced-pressure atmosphere facilitates permeation of monomer, dopant, oxidant or the like in the polymerization solution, resulting in a good solid electrolyte made of a conductive polymer.

After the solid electrolyte is formed in the foregoing manner, a sealing member is attached to the capacitor element using well-known material and technique. The capacitor element is thereafter placed in a case having a bottom, and an opening end portion of the case is subjected to lateral reduction, curling, or the like, resulting in a solid electrolytic capacitor. Here, a seat plate may be attached to allow for a surface-mount structure.

### EXAMPLES

### Example 1

An aluminum foil subjected to an etching process and having a dielectric coating film formed on the surface thereof was prepared as an anode foil. This anode foil and a cathode foil made of an aluminum foil were wound with separator paper interposed therebetween and were fixed by a fixing tape, resulting in a capacitor element. It is noted that a lead wire serving as a terminal was connected in advance to each of the anode foil and the cathode foil through a tab. Chemical conversion coating was thereafter performed on a cut portion of the anode foil.

Then, a monomer solution including 3,4-ethylenedioxythiophene as a monomer, an aqueous solution (dopant solution) including 75 wt % of phenolsulfonate 2-methylimidazole as a dopant, and an aqueous solution (oxidant solution) containing 45 wt % of ammonium persulfate as an oxidant were prepared. Here, the dopant solution was prepared to contain 0.3 mole of phenolsulfonate ion with respect to 1 mole of imidazolium ion. The capacitor element was dipped in the above-noted monomer solution. A solution including a dopant and an oxidant was prepared by mixing and stirring the above-noted dopant solution and the above-noted oxidant solution, so that the capacitor element was dipped in the solution including a dopant and an oxidant. The capacitor element was thereafter left for three hours under the atmospheric pressure at room temperature. The capacitor element was then dried by a heating treatment at about 120° C. At the same time, an oxidative polymerization reaction was performed. A solid electrolyte made of a conductive polymer was thus formed.

A sealing member made of an elastic material was attached to the capacitor element in which a solid electrolyte was formed in the foregoing manner. The capacitor element was then placed in an aluminum case having a bottom. Then, the opening end portion of the aluminum case having a bottom was subjected to lateral reduction or curling, followed by an aging treatment. A solid electrolytic capacitor was thus produced.

### Example 2

A solid electrolytic capacitor was produced in the similar manner as in Example 1 except that a dopant solution was prepared to contain 0.5 mole of sulfonate ion with respect to 1 mole of imidazolium ion.

### Example 3

A solid electrolytic capacitor was produced in the similar manner as in Example 1 except that a dopant solution was prepared to contain 1.1 moles of sulfonate ion with respect to 1 mole of imidazolium ion.

### Example 4

A solid electrolytic capacitor was produced in the similar manner as in Example 1 except that a dopant solution was prepared to contain 1.5 moles of sulfonate ion with respect to 1 mole of imidazolium ion.

### Example 5

A solid electrolytic capacitor was produced in the similar manner as in Example 1 except that a dopant solution was prepared to contain 2.0 moles of sulfonate ion with respect to 1 mole of imidazolium ion.

### Example 6

A solid electrolytic capacitor was produced in the similar manner as in Example 3 except that naphthalenesulfonate 2-methylimidazole was used as a dopant.

### Comparative Example 1

A solid electrolytic capacitor was produced in the similar manner as in Example 1 except that a dopant solution and an oxidant solution were not separately prepared and a butanol solution of ferric p-toluenesulfonate was used as a dopant and oxidant solution. Here, the dopant and oxidant solution was prepared such that the inclusion ratio of p-toluenesulfonate ion to ferric ion was 3 moles of p-toluenesulfonate ion to 1 mole of ferric ion.

For Examples 1-6 and Comparative Example 1, the capacitance [μF] at a frequency of 120 Hz and the ESR (Equivalent Series Resistance) [mΩ] at a frequency of 100 kHz were measured. Then, after a reflow test was performed under the conditions of a temperature of 230° C. to 250° C. for 30 seconds, the capacitance and the ESR were measured under the same conditions. The capacitance change rate [%] and the ESR change rate [times] were thus measured. In addition, the number of short-circuit failures after the reflow test was determined. The result is shown in Table 1.

Here, the capacitance and the ESR before the reflow test are expressed as the initial capacitance and the initial ESR, respectively. The capacitance and the ESR after the reflow test are expressed as the capacitance after test and the ESR after test, respectively. The values of the capacitance and the ESR shown in the table each are the mean value of the measured values for 30 solid electrolytic capacitors produced in the same manner, and the number of short circuits is obtained from the same 30 solid electrolytic capacitors.

TABLE 1

| | initial | initial | capacitance | ESR after | capacitance | ESR | |
|---|---|---|---|---|---|---|---|
| | capacitance | ESR | after test | test | change rate | change rate | number of |
| | [μF] | [mΩ] | [μF] | [mΩ] | [%] | [times] | short-circuits |
| EXAMPLE 1 | 150 | 34.5 | 142 | 50.0 | −5.3 | 1.45 | 1 |
| EXAMPLE 2 | 155 | 26.4 | 151 | 27.5 | −2.4 | 1.04 | 0 |
| EXAMPLE 3 | 152 | 23.2 | 149 | 23.4 | −2.3 | 1.01 | 0 |
| EXAMPLE 4 | 151 | 25.7 | 145 | 27.8 | −3.7 | 1.08 | 0 |
| EXAMPLE 5 | 149 | 30.7 | 142 | 37.5 | −4.6 | 1.22 | 2 |
| EXAMPLE 6 | 126 | 36.2 | 120 | 36.9 | −4.4 | 1.02 | 1 |
| COMPATATIVE | 149 | 33.3 | 141 | 59.9 | −5.5 | 1.80 | 4 |
| EXAMPLE 1 | | | | | | | |

As can be understood from Table 1, in the solid electrolytic capacitors of Examples 1-6 using an imidazolium salt of sulfonic acid as a dopant, the capacitance change rate and the ESR change rate are small before and after the reflow, and in addition, short-circuit failures are suppressed, as compared with Comparative Example 1 using ferric p-toluenesulfonate serving as a dopant and an oxidant. Therefore, these solid electrolytic capacitors are excellent in heat resistance. Furthermore, considering the capacitance before the reflow, Examples 1-5 using phenolsulfonate 2-methylimidazole as a dopant have a larger capacitance and have excellent characteristics as compared with Example 6 using naphthalenesulfonate 2-methylimidazole as a dopant.

In comparison of Examples 2-4 with Examples 1 and 5, when phenolsulfonate ion is contained in a ratio of 0.5-1.5 moles to 1 mole of imidazolium ion in the dopant solution, the capacitance change rate and the ESR change rate are small so that the heat resistance is excellent.

Next, a manufacturing method using an oxidative polymerization reaction under a reduced-pressure atmosphere was examined.

### Example 7

After a capacitor element was impregnated with a polymerization solution, the capacitor element was left for three hours at room temperature under a reduced-pressure atmosphere in which the atmospheric pressure was reduced by 75 kPa, instead of being left for three hours at room temperature under the atmospheric pressure. Except for this, in the similar manner as in Example 3, a solid electrolytic capacitor was produced.

### Example 8

After a capacitor element was impregnated with a polymerization solution, the capacitor element was left for three hours at room temperature under a reduced-pressure atmosphere in which the atmospheric pressure was reduced by 80 kPa, instead of being left for three hours at room temperature under the atmospheric pressure. Except for this, in the similar manner as in Example 3, a solid electrolytic capacitor was produced.

### Example 9

After a capacitor element was impregnated with a polymerization solution, the capacitor element was left for three hours at room temperature under a reduced-pressure atmosphere in which the atmospheric pressure was reduced by 90 kPa, instead of being left for three hours at room temperature under the atmospheric pressure. Except for this, in the similar manner as in Example 3, a solid electrolytic capacitor was produced.

### Example 10

After a capacitor element was impregnated with a polymerization solution, the capacitor element was left for three hours at room temperature under a reduced-pressure atmosphere in which the atmospheric pressure was reduced by 100 kPa, instead of being left for three hours at room temperature under the atmospheric pressure. Except for this, in the similar manner as in Example 3, a solid electrolytic capacitor was produced.

For Examples 3 and 7-10, the capacitance [μF] at a frequency of 120 Hz and the ESR [mΩ] at a frequency of 100 kHz were measured. Then, after a reflow test was performed under the conditions of a temperature of 230° C. to 250° C. for 30 seconds, the capacitance and the ESR were measured. The capacitance change rate [%] and the ESR change rate [times] were thus measured. The result is shown in Table 2.

Here, the capacitance and the ESR before the reflow test are expressed as the initial capacitance and the initial ESR, respectively. The capacitance and the ESR after the reflow test are expressed as the capacitance after test and the ESR after test, respectively. The values of the capacitance and the ESR shown in the table each are the mean value of the measured values for 30 solid electrolytic capacitors produced in the same manner.

TABLE 2

| | initial | initial | capacitance | ESR after | capacitance | ESR |
|---|---|---|---|---|---|---|
| | capacitance | ESR | after test | test | change rate | change rate |
| | [μF] | [mΩ] | [μF] | [mΩ] | [%] | [times] |
| EXAMPLE 3 | 152 | 23.2 | 149 | 23.4 | −2.3 | 1.01 |
| EXAMPLE 7 | 152 | 23.3 | 149 | 23.5 | −2.0 | 1.01 |
| EXAMPLE 8 | 155 | 20.1 | 153 | 20.1 | −1.5 | 1.00 |
| EXAMPLE 9 | 159 | 19.8 | 158 | 19.8 | −0.9 | 1.00 |
| EXAMPLE 10 | 160 | 17.2 | 159 | 17.2 | −0.8 | 1.00 |

As can be understood from Table 2, in Examples 7-10 in which a chemical polymerization reaction was performed under a reduced-pressure atmosphere, the capacitance change rate is small and heat resistance is excellent, as compared with Example 3 obtained by leaving the capacitor element in the atmospheric pressure. In particular, when the atmospheric pressure was reduced by 80 kPa or more (Examples 8-10), the ESR before the reflow is kept low, which indicates that a solid electrolyte having excellent conductivity was formed.

The aforementioned examples are only shown to illustrate the present invention and should not be understood as limiting the invention recited in the claims. The present invention can be changed freely within the scope of the claims and within the scope of the equivalents thereof. For example, the solid electrolytic capacitor described in the embodiment and examples is formed of a capacitor element formed by winding an anode foil and a cathode foil. The present invention, however, is not limited thereto and is applicable to a capacitor element obtained by forming a dielectric coating film, a solid electrolyte, and a cathode lead-out layer on a circumferential surface of a sintered valve action metal or a valve action metal foil.

What is claimed is:

1. A method of manufacturing a solid electrolytic capacitor including a solid electrolyte made of a conductive polymer, comprising the step of forming said conductive polymer by performing an oxidative polymerization reaction by bringing a monomer and a dopant into contact with each other, wherein said dopant contains an imidazolium salt of sulfonic acid.

2. The method of manufacturing a solid electrolytic capacitor according to claim 1, wherein
said imidazolium salt of sulfonic acid is formed of a sulfonate ion and an imidazolium ion, and
said sulfonate ion is phenolsulfonate ion.

3. The method of manufacturing a solid electrolytic capacitor according to claim 1, wherein
said imidazolium salt of sulfonic acid is formed of a sulfonate ion and an imidazolium ion, and
said imidazolium ion is 2-methylimidazolium ion.

4. The method of manufacturing a solid electrolytic capacitor according to claim 1, wherein
said imidazolium salt of sulfonic acid is formed of a sulfonate ion and an imidazolium ion, and
said sulfonate ion is included in an amount of 0.5-1.5 moles with respect to 1 mole of said imidazolium ion, in a solution containing said dopant for use in said oxidative polymerization reaction.

5. The method of manufacturing a solid electrolytic capacitor according to claim 1, wherein an ammonium salt is additionally used as an oxidant in said oxidative polymerization reaction.

6. The method of manufacturing a solid electrolytic capacitor according to claim 1, wherein said oxidative polymerization reaction is performed under a reduced-pressure atmosphere.
